(19) United States
(12) Patent Application Publication
(10) Pub. No.: US 2026/0322300 A1
(43) Pub. Date: Oct. 15, 2026

(54) METHOD FOR CLOSED-LOOP CONTROL OF MECHANICALLY FIELD-WEAKENED ELECTRIC MACHINES

(71) Applicant: Schaeffler Technologies AG & Co. KG, Herzogenaurach (DE)

(72) Inventors: Matthias Brodatzki, Pfinztal (DE); Miriam Axtmann, Marxzell (DE); Florian Eberhardt, Stuttgart (DE)

(73) Assignee: Schaeffler Technologies AG & Co. KG, Herzogenaurach (DE)

(21) Appl. No.: 19/484,369

(22) PCT Filed: Apr. 23, 2024
(86) PCT No.: PCT/DE2024/100362

§ 371 Date: Nov. 14, 2025

(30) Foreign Application Priority Data
May 15, 2023 (DE) 10 2023 112 743.8

(51) Int. Cl. H02P 23/00

(52) U.S. Cl. CPC H02P 23/009

(57) ABSTRACT

A method for closed-loop control of mechanically field-weakened electric machines is provided. A target current value and a target value of the mechanical field weakening are determined using a module for the target open-loop control values of the electric machine. A state of the field weakening is determined using a module for observing the state of the mechanical field weakening of the electric machine. A target value of the current which influences the state of the mechanical field weakening is determined using a module for closed-loop control of the mechanical field weakening of the electric machine. A target value of the inverter voltage is determined using a module for the closed-loop current control of the electric machine and the target value is supplied to the electric machine.

### CROSS-REFERENCE TO RELATED APPLICATIONS

This application is the United States National Phase of International Application PCT/DE2024/100362, filed Apr. 23, 2024, which claims priority to German Application 10 2023 112 743.8, filed May 15, 2023. The disclosures of the above applications are incorporated herein by reference.

### TECHNICAL FIELD

The disclosure relates to a method for the closed-loop control of mechanically field-weakened electric machines.

### BACKGROUND

A permanent magnet synchronous machine is generally used for traction drives. It is characterized by a high degree of power density and can be operated more efficiently compared to other machine types. However, the presence of magnets means that the magnetization of the rotor cannot be changed during operation. This can lead to increased iron losses at operating points where the high magnetic flux of the rotor is not required. In this regard, the operating points with increased losses often fall within the range of the machine characteristic map that is particularly relevant for operation in standardized reference driving cycles. However, the rotor magnetic flux is necessary to achieve higher torques in an efficient manner so that the machine cannot be designed with a lower magnetic flux.

It is therefore desirable to be able to change the rotor magnetization while the machine is in operation. Electrically energized machines constitute one possibility in this respect, but they suffer additional losses due to the energization of the magnetization windings. Mechanically adjustable machines, which are characterized by variable machine characteristics during operation, were therefore proposed as a solution. The magnetic resistance that the magnetic flux of the rotor magnets has to overcome is, in this regard, varied by way of mechanical interventions and or additional scattering paths are introduced. In this context, a higher magnetic resistance leads to a reduction in the flux caused by the magnets in the stator and thus reduced iron losses. The intervention is referred to as a mechanical field weakening. This type of intervention, the mechanical field weakening, can also provide for a reduction in the required field weakening current above the base speed and thus also improve efficiency.

The German patent application DE 10 2021 124 533 relates to an electric machine that includes a stator and a rotor having a mechanical air gap adjustment coupled to the rotor and/or stator. The method refers to the circumstance that a moment/force balance between mechanics and adjustment forces generated by the machine can be achieved by an adjustment of id and iq. A steady operating point is established. If the impression of id and iq is changed, this can also influence the moment/force balance and a new operating point with a different mechanical field weakening position is established.

The German patent application DE 10 2021 124 534 relates to an electric machine comprising a stator and a rotor, wherein a motor torque and/or a motor force can be introduced into the rotor via a magnetic field generated by the stator. The open-loop control method describes that energizing a machine creates a torque or force impulse that can put the machine into a second operating state, as this creates a brief force imbalance in the first operating state and a switchover to a second state (new equilibrium state) takes place.

The German patent application DE 10 2020 117 257 A1 describes field weakening by means of mechanical reduction of the magnetic material in the rotor.

The patent DE 10 2020 115 367 B3 relates to a mechanical field weakening due to radial air gap changes caused by a conical displacement mechanism in the rotor. A synchronous machine has multiple permanent magnets arranged distributed around the rotor circumference, which are arranged so as to be radially displaceable in an axially position-fixed magnet holder and are mounted directly or indirectly on one or more wedge surfaces of an axially displaceable wedge element, which can be moved axially in a controlled manner via a hydraulically or pneumatically actuated control element.

The patent DE 10 2020 115 365 B3 relates to a rotor for a synchronous machine having multiple permanent magnets arranged distributed around the rotor circumference. The permanent magnets are arranged so as to be radially displaceable in an axially position-fixed magnet holder and are mounted directly or indirectly on one or more wedge surfaces of an axially displaceable wedge element, which can be moved axially via a control element actuated in a torque-dependent manner on the basis of a torque acting on the rotor.

The Chinese patent application CN 101783536 A relates to the adjustment of magnetic short-circuit paths in the rotor by means of speed-dependent centrifugal forces.

The German patent application DE 10 2009 038 928 A1 relates to an electric motor having a stator, a rotor and an air gap formed between the stator and rotor. The size of the air gap varies on the basis of the speed of the electric motor, wherein the air gap is enlarged at higher speeds of the rotor.

The European patent application EP 2 985 893 A relates to an electric machine having at least one stator and one rotor. The rotor is connected to a rotor shaft, wherein stator segments are arranged immovably relative to the bearing in the rotational direction of the rotor. However, at least one of the stator segments is movably arranged in the axial or radial direction relative to the bearing in order to set the width of the air gap between the rotor and stator segments. The adjustment is to be carried out with an adjusting unit, for which compressed air, for example, is suggested.

The Japanese patent application JP 2007244027 describes a dynamoelectric machine that can reduce the induced voltage in a simple structure. If the rotor torque is high, the cam mechanism equipped with the ball brings the rotor close to the stator. If the rotor torque is low, the cam mechanism moves the rotor away from the stator, increasing the magnetic resistance of a magnetic circuit formed between the rotor and the stator. As a result, the induced voltage can be reduced.

The U.S. Pat. No. 5,821,710 (A) describes a brushless motor with permanent magnets. A first field permanent magnet and a second field permanent magnet are provided, where the first field permanent magnet is rotatable relative to the second field permanent magnet.

The publication FR 2831345 discloses an electric machine, where the rotor is provided with four permanent magnets. The air gap flux is reduced by rotating the rotor discs. The rotation causes some of the magnetic flux to be diverted via the rotor, reducing the air gap flux for variable speed operation.

The publications EP 1 085 644 B1, US 2002/117933 A1, US 2004/021390 A1 and US 2010/252341 A1 disclose an actuator for adjustment in the field weakening range.

The European patent EP 1 867 030 B1 discloses the adjustment of rotor discs in relation to one another by means of an actuator in conjunction with a control unit.

The Chinese patent CN 104600929 B shows two rotor discs that are rotated against one another. Springs provide for the closed-loop control and carry out the adjustment of the torque.

The Chinese patent application CN 105449969 A discloses two rotor discs, the adjustment of which in relation to one another is carried out automatically based on the load torque.

In the publications WO 2016/000697 A1 and US 2017/163109 A1, a dynamoelectric machine with mechanical field weakening is provided. The radial position can be influenced by flux guiding elements, which are controlled in a closed-loop by means of centrifugal force or springs.

The US patent application US 2017/163108 A1 discloses a dynamoelectric permanently excited machine with the possibility of mechanical field weakening. A centrifugal force-controlled field weakening device is provided. In order to increase operational safety, the machine also comprises a signal input for an error signal and an actuator for speed-independent control of the field weakening device to reduce short-circuit torque or overvoltage.

The patent application WO 2016/000697 A1 describes a dynamoelectric permanently excited machine. The permanent magnets can penetrate at least partially into magnetic pockets, where the penetration depth of the permanent magnets depends on their radial position and the density of the magnetic air gap flux. The field is weakened by an actuator if an error signal is present.

The US patent application US 2013/0200739 A1 discloses a unit for adapting the magnetic flux. The flux can be adjusted at variable speeds.

The European patent application EP 3 232 547 A1 relates to a method for operating an electric machine comprising a stator and a rotor that can rotate relative to the stator. The different poles of the magnetic elements in one direction of rotation of the rotor are arranged in an alternating manner.

The German patent application DE10 2010 002 401 A1 discloses a magnetic flux control mechanism that controls magnetic fluxes by varying the positions of the field magnets of the second rotor.

The international patent application WO 2022/162076 A1 discloses an axial flux machine, where the rotor includes a first and a second rotor disc. An axial displacement of the first or second rotor disc relative to the switching element is made possible by rotating the first or second rotor disc.

The US patent application US 2021/376705 A1 relates to a permanent magnet motor with a rotor. The rotor includes a mechanical field weakening arrangement that weakens a flux of the permanent magnet motor. The permanent magnet can be deformed by a centrifugal force provided by the rotation of the rotor.

The US patent application US 2009/0140591 A1 relates to an electric synchronous machine. The two rotor sections can move relative to one another at least between a first and a second relative position in such a way that the rotor flux provided by the rotor is of a different magnitude in the two relative positions.

Solutions were presented for two machines that differ in the spatial orientation of the relevant magnetic field. With an axial flux machine (AFM), the stator coils and the rotor magnets are offset from one another in the axial direction. With a radial flux machine (RFM), the stator coils are mounted around the rotor and provide for a mainly radially oriented magnetic field. In both cases, the mechanical field weakening can be triggered by way of targeted action.

In methods that achieve adjustment by way of effective torques, a stationary current operating point (such as a d and q current pair) may lead to an adjustment, but a predefined field weakening state cannot be achieved in a targeted manner.

There are two types of field weakening in a mechanically field-weakened machine. The first possibility is that weakening of the flux is achieved purely due to the impressed current (without adjustment of the mechanical field weakening mechanism). The second possibility is that the field weakening is achieved by adjusting the mechanical field weakening mechanism. When the application text refers to mechanical field weakening, it refers to the mechanical adjustment of the mechanism used to achieve the mechanical field weakening.

### SUMMARY

The disclosure provides a method for the closed-loop control of mechanically field-weakened electric motors, in which it is possible to adjust and maintain a desired machine characteristic of a mechanically field-weakened machine with the boundary condition of minimizing losses in a targeted manner.

As such, a module for the target open-loop control values of the electric machine is first used to determine a target current value (in the d and q directions) and a target value for the mechanical field weakening from a target torque value, the current speed value and the current supply voltage value of the electric machine. A module for observing the mechanical field weakening of the electric machine is used to determine the state of the mechanical field weakening. The target current value, the target value of the mechanical field weakening and the state of the mechanical field weakening are transferred to a calculator for the closed-loop control of the mechanical field weakening. This controller, implemented in the module for the closed-loop control of the mechanical field weakening of the electric machine, determines a d and q current that favors the adjustment of the mechanical field weakening mechanism towards the target value of the mechanical field weakening. The output of the module for the closed-loop control of the mechanical field weakening is added to the target current value in the first calculator and thus represents the closed-loop control target for the inverter. A module for the closed-loop current control of the electric machine is used to determine a target value for the inverter voltage and this target value is supplied to the electric machine.

In some implementations, the method may be carried out in a dynamic and precise manner, as it includes the closed-loop control, suitable selection of the control variables and observing the state of the mechanical field weakening.

The adjustment of the state of the mechanical field weakening is to be performed without an additional actuator (installation space, costs, losses) and independent of the speed. In this regard, the method avoids an adjustment being achieved only via centrifugal forces or speeds of the electric machine, which prevents loss-optimized operation in the low or high speed range.

An adjustment can be achieved by dynamic current changes and also depends on the torques acting on the output. However, the current trajectories in the current state space that must be traversed in order to achieve the adjustment cannot be efficiently calculated and stored in advance. They depend on a variety of parameters, such as temperature, voltage limitation of the power electronics as well as hysteresis and other non-linearities and tolerances of the adjustment device itself. The influence of fluctuating torque effects on the output (such as a changing road surface, potholes) must also be compensated for and influences the required current control.

In addition, knowledge of the current state is required to determine and adjust the mechanical field weakening in a targeted manner. This can be achieved using additional sensor systems. However, if no additional sensor can be integrated (due to costs, installation space) or if the additional sensor system fails, it must be possible to estimate the state from the remaining measured variables (such as by means of observing).

The closed-loop control makes it possible to adjust and maintain a desired machine characteristic of a mechanically field-weakened electric machine with the boundary condition of minimizing losses in a targeted manner. In this regard, the targeted adjustment is carried out by way of a closed-loop control with target value transfer and state observance, which generates the required trajectory in the current state space. This targeted state adjustment is not known from the prior art.

This novel closed-loop control concept is implemented by influencing the state of the mechanical field weakening using the phase currents. Target value tables are provided for the currents and the state of the adjustable components of the electric machine with an influence on the machine characteristics. The table is optimized with regard to total losses of the drive system or the electric machine.

The state of the adjustable components can be influenced by a separate controller. Without a controller, the result in most cases is a deviation from the target value. The control variables are usually the machine currents of the electric machine.

Maximum influence with minimum control intervention is achieved by determining the optimal current distribution (d and q components, phase position, etc.). In this regard, an optimization target can be a current change along a hyperbola with constant torque (partial torques are changed, total torque remains constant). This may require higher currents for a short time for a specific adjustment. Minimizing the torque deviation is achieved at the expense of current heat losses.

A current change in the direction of maximum partial torque change allows for the fastest possible adjustment. The result is a minimization of current heat losses at the expense of torque deviation.

A measured current from the electric machine is supplied to the first calculator for superimposition. An optimized phase angle table of the module, which contains the optimal current distribution, such as in d and q components of the current, is supplied with a measured current of the electric machine for the closed-loop control of the mechanical field weakening. The optimized phase angle table achieves maximum influence with minimum control intervention. This includes determining the optimal current distribution (d and q components, phase position, etc.). The target value of the mechanical field weakening is supplied to the second calculator and reaches the module for the closed-loop control of the mechanical field weakening via this calculator as a control target.

Steady-state accuracy can be achieved by way of an integral component in the controller, but this results in a steady-state deviation from the (optimal) target current values. Alternatively, the mechanical properties (such as friction) of the adjustment device can be used to maintain the adjustment after it has been made by influencing the currents.

An increase in losses due to higher currents or a deviation from the target value must be evaluated. The deviation even without the I component is significantly lower than without any closed-loop control at all.

The state of the adjustable components cannot be easily measured.

The state estimation can be achieved by way of an observer concept and using the model knowledge and measurement of the electric variables and one or no rotor position. The rotor position can be understood as the angle of the shaft or a rotor body to the stator. A comparison is made between model variables and actual measured variables (variables are based on the adjustment in each case) and allows the estimated mechanical field weakening state to be followed. The state estimation is made possible by way of an observer concept and by utilizing the model knowledge and measurement of electric variables, where a rotor position measurement is not necessary.

The state can be measured by way of additional sensor systems, such as further rotor position sensors in the case of two or more partial rotors.

The change in state of the adjustable components leads to a change in the flux linkage and represents an interference effect on the current controllers. A feedforward control of the induced voltage is possible and necessary, as otherwise deviations from the optimal current trajectory may occur.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows an electric machine according to the prior art in a cross-sectional view.

FIG. 2 shows a rotor with a mechanical field weakening mechanism according to the prior art in a neutral position in a schematic block diagram,

FIG. 3 shows a schematic representation of an exemplary method for the closed-loop control and influencing of the state of the mechanical field weakening.

FIG. 4 shows the target open-loop control values that are a component of the exemplary method shown in FIG. 3.

FIG. 5 shows the observer of the mechanical field weakening that is a component of the exemplary method shown in FIG. 3.

FIG. 6 shows the closed-loop current control that is a component of the exemplary method shown in FIG. 3.

FIG. 7 shows the closed-loop control of the mechanical field weakening that is a component of the method shown in FIG. 3.

Like reference symbols in the various drawings indicate like elements.

### DETAILED DESCRIPTION

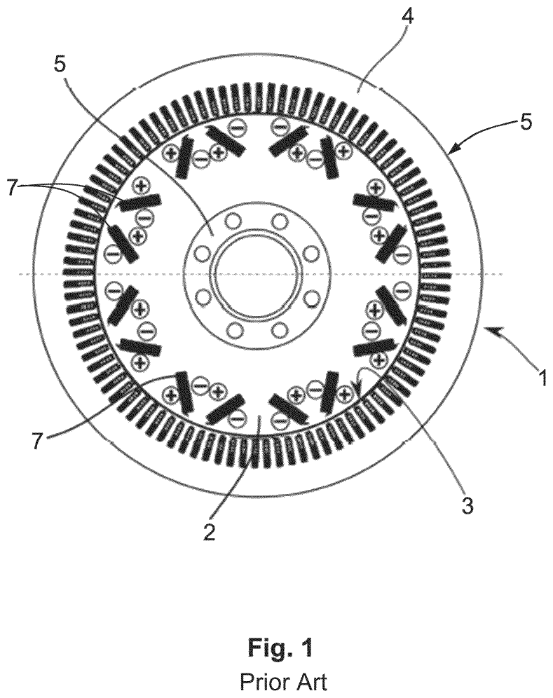

FIG. 1 shows an electric machine 1 configured as a radial flux machine, for use in the drive train of a hybrid or fully electrically powered motor vehicle, the electric machine 1 includes a stator 4 and a rotor 2 separated from the stator 4 by an air gap 3. The “+” sign shown in FIG. 1 stands for the north pole and the “−” sign stands for the south pole of the magnets.

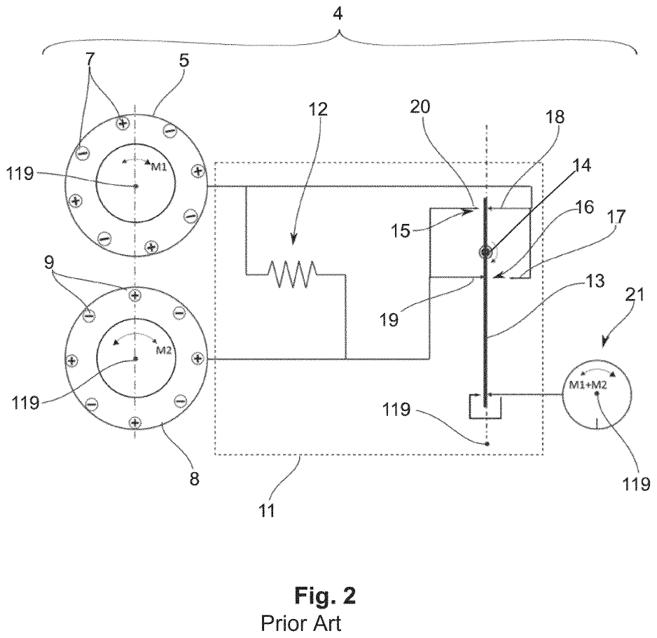

As apparent from the synopsis of FIG. 1 and FIG. 2, the rotor 2 includes at least one first rotor body 5 having at least one permanent magnet 7 and a second rotor body 8 having a second group 10 with at least one permanent magnet 7 (in the representation of FIG. 1, the second rotor body 8 with the permanent magnets 9 is not visible, as it is arranged behind the first rotor body 5). The first rotor body 5 and the second rotor body 8 are essentially formed from identical rotor laminations, where the position and the number of permanent magnets 7 in the first rotor body 5 and the number of permanent magnets 9 in the second rotor body 8 are identical.

The first rotor body 5 and the second rotor body 8 are rotatable relative to one another about a common axis of rotation 119 against the effect of a first torsional stiffness 12 by way of a mechanical field weakening mechanism 11. The mechanical field weakening mechanism 11 includes a lever element 13 that is pivotable about a pivot point 14, where the first rotor body 5 can be coupled to a first lever section 15 and the second rotor body 8 can be coupled to a second lever section 16 of the lever element 13, and the first lever section 15 and the second lever section 16 are arranged on opposite sides of the lever element 13. The first rotor body 5 and the second rotor body 8 are rotated relative to one another in a targeted manner by tilting the lever element 13 to achieve the desired adjustment of the mechanical field weakening mechanism 11.

The mechanical field weakening mechanism 11 uses the lever element 13 at at least two circumferential points of the rotor bodies 5, 8 within the rotor 4, also referred to as lever contact sections 17, 18, 19, 20, to transmit the partial torques of the two rotor bodies 5, 8 to the rotor shaft 21 with the torsional stiffness 12 simultaneously acting between the rotor bodies 5, 8. In this respect, the lever element 13 has three regions at different distances from the axis of rotation 119 of the rotor 4, in which it is in contact with the two rotor bodies 5, 8 as the two inputs for the torque and the rotor shaft 21 as the output for the torque. The three regions of the lever element 13 are the first lever section 15, the second lever section 16 and the unspecified contact section at the radially inner end of the lever element 13 to the rotor shaft 21.

FIG. 2 shows the mechanical field weakening mechanism 11 in its neutral position. The mechanical field weakening mechanism 11 is in a field-weakened position here, with the magnetic poles of the permanent magnets 7 not aligned with the permanent magnets 9, which can be easily understood on the basis of the angle of rotation of the two rotor bodies 5, 8 in FIG. 2. In this case, the total torque is lower than the minimum torque required to allow adjustment of the rotor bodies 5, 8 relative to one another to begin against the possibly preloaded torsional stiffness 12. The characteristic curve of the torsional stiffness 12 is selected such that when a specified minimum torque of the mechanical field weakening mechanism 11 is exceeded, it begins to adjust from the maximum field-weakened position and when a specified higher torque is reached and exceeded, full adjustment to the position with a full magnetic field is completed.

The first partial torque M1 is transmitted via the lever contact sections 17, 18 of the first rotor body 5 depending on the direction of the total torque, where the first lever contact section 17 of the first rotor body 5 is arranged to be radially inwardly offset from the second lever contact section 18. Similarly, the second partial torque M2 of the second rotor body 8 is transmitted to the lever element 13 via the lever contact sections 19, 20, depending on the direction of the total torque. The first lever contact section 19 of the second rotor body 8 is arranged to be radially inwardly offset from the second lever contact section 20.

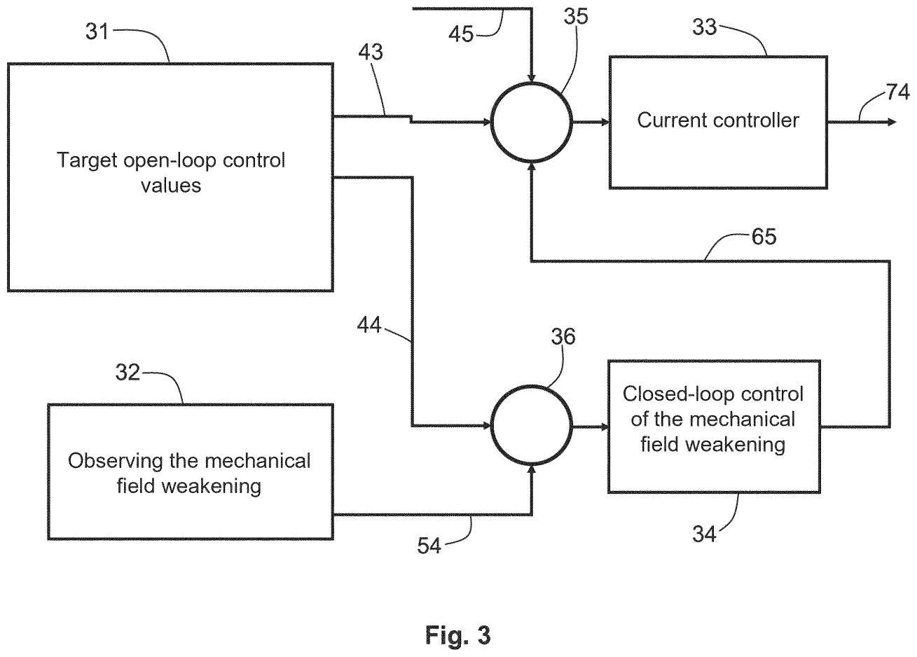

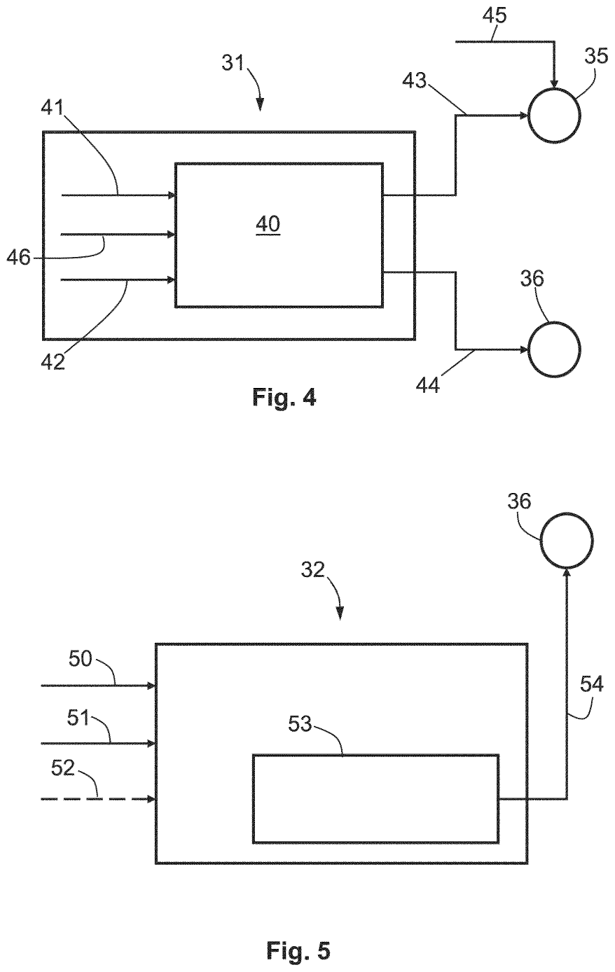

FIG. 3 shows a schematic representation of an exemplary method for the closed-loop control and influencing of the state of the mechanical field weakening of an electric machine 1 (cf. FIG. 1). The method includes a module 31 for the target open-loop control values of the electric machine 1, a module 32 for observing the mechanical field weakening of the electric machine 1, a module 33 for the closed-loop current control of the electric machine 1 and a module 34 for the closed-loop control of the mechanical field weakening of the electric machine 1. The method receives a target torque value 41, an actual supply voltage value 46 and an actual speed value 42 (cf. FIG. 4) of the electric machine 1 as input at the module 31 for the target open-loop control values. The electric machine 1 receives a target value 74 for the inverter voltage for controlling the electric machine 1 from the module 33 for the closed-loop current control.

FIG. 4 shows a schematic of the method for the closed-loop control and influencing of the state of the mechanical field weakening. The module 31 for the target open-loop control values includes a memory 40 for tables with target current values and target values for the mechanical field weakening. These are optimized, for example, with regard to the efficiency of the electric machine or the overall system including the electric machine 1 and the inverter or, for example, with regard to the acoustics. A target torque value 41, an actual supply voltage value 46 and an actual speed value 42 are supplied to the memory 40 as inputs. On the basis of the tables, a target current value 43 and a target value of the mechanical field weakening 44 are determined from the target torque value 41, the actual supply voltage value 46 and the actual speed value 42. The target current value 43 is supplied to a first calculator 35 for superimposition, where it is superimposed with a measured current 45 (measured current of the electric machine 1). The target value 44 of the mechanical field weakening is supplied to a second calculator 36 for superimposition. The first calculator 35 and the second calculator 36 represent an addition/subtraction of the supplied values.

The tables represent currents and the state of the adjustable components, which represents the influence on the characteristics of the electric machine 1. The table or tables are optimized with regard to the total losses of the drive system or electric machine 1.

FIG. 5 shows the module 32 for observing the mechanical field weakening that is a component of the method shown in FIG. 3. A measured current 50 and a measured position 51 of the electric machine 1 are supplied to the module 32 for observing the mechanical field weakening. Furthermore, at least one further parameter 52 can be supplied to the module 32 for observing the mechanical field weakening. The module 32 for observing the mechanical field weakening allows for a state estimation by utilizing the model knowledge and measuring electric variables and a position of the rotor 4 or the at least two rotor bodies 5, 8 or even without measuring a rotor angle information. The comparison of model variables and actual measured variables (variables depending on the adjustment of the two rotor bodies 5, 8 in each case) allows the estimated mechanical field weakening state to be followed. The state estimation by the module 32 for observing the mechanical field weakening is performed by utilizing model knowledge and measuring electric variables without measuring the rotor position. The module 32 for observing the mechanical field weakening may include additional sensor systems 53 for the state measurement, such as further sensors for the rotor position in the case of two or more rotor bodies 5, 8 (partial rotors). The output of the module 32 for observing the mechanical field weakening provides the state 54 of the mechanical field weakening, which is supplied to the second calculator 36 as the actual value of the state of the mechanical field weakening.

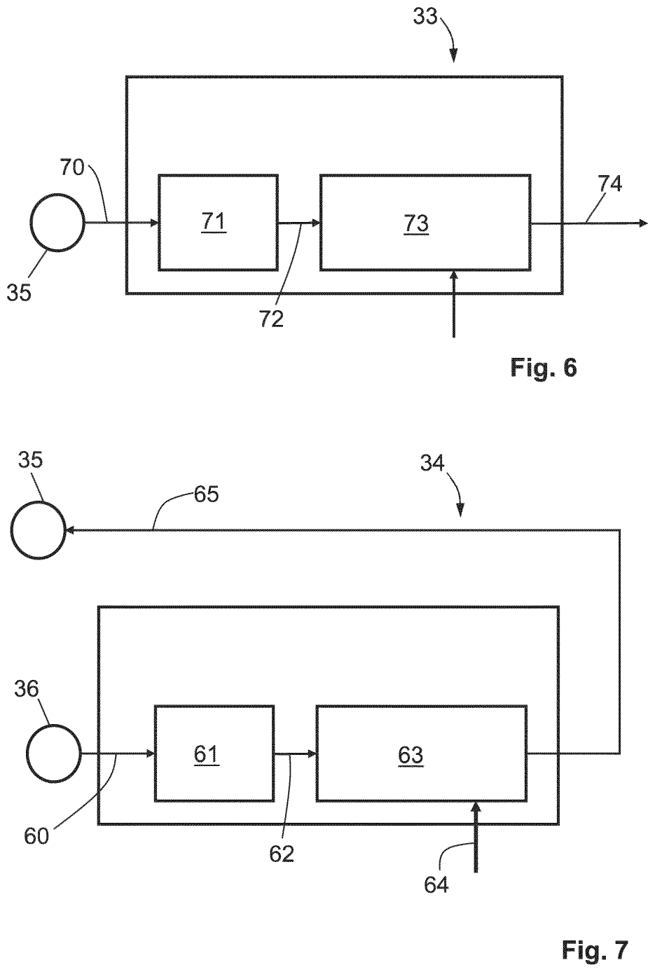

FIG. 6 shows the module 33 for the closed-loop current control that is a component of the method shown in FIG. 3. An output 70 of the first calculator 35, which has as its input the target current value 43 (cf. FIG. 3), the measured current 45 (cf. FIG. 3) and an output 65 of the module 34 for the closed-loop control of the mechanical field weakening 34, which represents the target value of the mechanical field weakening current, is supplied to a PID controller 71 (proportional-integral-derivative controller) of the closed-loop current control 33. An output 72 of the PID controller 71 is supplied to a compensation 73 of the interference voltage 75 due to the change in the state of the mechanical field weakening. The change in the state of the mechanical field weakening is also supplied to the input of the compensation 73 for the closed-loop current control. An output of the module 33 for the closed-loop current control provides a target value 74 for the inverter voltage, which is sent to the electric machine 1 for control purposes.

FIG. 7 shows the module 34 for the closed-loop control of the mechanical field weakening that is a component of the method shown in FIG. 4. As shown in FIG. 3, the target value of the mechanical field weakening 44 and the actual state of the mechanical field weakening 54 are supplied to the calculator 36. The output 60 of the calculator 36 is supplied to the PID controller 61 in the module 34 for the closed-loop control of the mechanical field weakening. The state of the adjustable components is influenced by the PID controller 61. Without the PID controller 61, the result in most cases is a deviation from the target value. An output of the PID controller 62 is supplied to a phase angle table 63, which allows for optimization with regard to the maximum effect on mechanical field weakening or to an effect on the mechanical field weakening with further boundary conditions. A feedforward control of the induced voltage is possible and necessary, as otherwise deviations from the optimal current trajectory may occur. A measured current 64 is supplied to the phase angle table 63. The measured current or currents 64 are currents of the electric machine 1. A target value 65 for the mechanical field weakening current is determined using the module 34 for the closed-loop control of the mechanical field weakening. The target value 65 of the mechanical field weakening current is supplied to the first calculator 35.

A number of implementations have been described. Nevertheless, it will be understood that various modifications may be made without departing from the spirit and scope of the disclosure. Accordingly, other implementations are within the scope of the following claims.

REFERENCE NUMERALS

| | |
|---|---|
| 1 | Electric machine |
| 2 | Rotor |
| 3 | Air gap |
| 4 | Stator |
| 5 | First rotor body |
| 7 | Permanent magnet |
| 8 | Second rotor body |
| 9 | Permanent magnet |
| 11 | Mechanical field-weakening mechanism |
| 12 | Torsional stiffness |
| 13 | Lever element |
| 14 | Pivot point |
| 15 | First lever section |
| 16 | Second lever section |
| 17 | Lever contact section |
| 18 | Lever contact section |
| 19 | Lever contact section |
| 20 | Lever contact section |
| 21 | Rotor shaft |
| 31 | Module for target open-loop control values |
| 32 | Module for observing the mechanical field weakening |
| 33 | Module for the closed-loop current control |
| 34 | Modules for the closed-loop control of the |
| | mechanical field weakening |
| 35 | First calculator |
| 36 | Second calculator |
| 40 | Memory |
| 41 | Target torque value |
| 42 | Actual speed value |
| 43 | Target current value |
| 44 | Target value of the mechanical field weakening |
| 45 | Measured current |
| 46 | Actual supply voltage value |
| 50 | Measured current |
| 51 | Measured position |
| 52 | Further parameter |
| 53 | Sensor system |
| 54 | State of the mechanical field weakening |
| 60 | Output |
| 61 | PID controller |
| 62 | Output |
| 63 | Phase angle table |
| 64 | Measured current |
| 65 | Target value |
| 70 | Output |
| 71 | PID controller |
| 72 | Output |
| 73 | Compensation |
| 74 | Target value |
| 75 | Interference voltage |
| 119 | Axis of rotation |
| M1 | Partial torque |
| M2 | Partial torque |

1. A method for a closed-loop control of mechanically field-weakened electric machines, the method comprising:
determining a target current value and a target value of the mechanical field weakening from a target torque value;
determining an actual speed value of the electric machine using a module for a target open-loop control values of the electric machine;
supplying the target current value to a first calculator for superimposition;
supplying the target value of the mechanical field weakening is supplied to a second calculator for superimposition;
determining a state of the mechanical field weakening using a module for observing the mechanical field weakening of the electric machine, wherein the state of the mechanical field weakening is supplied to the second calculator for superimposition;
determining a target value of the current which influences the state of the mechanical field weakening based on the target value and the actual value of the state of the mechanical field weakening using a module for the closed-loop control of the mechanical field weakening of the electric machine; and
determining a target value of an inverter voltage based on an output of the first calculator using a module for the closed-loop current control of the electric machine and said target value is supplied to the electric machine.

2. The method of claim 1, further comprising:
supplying a measured current from the electric machine, a target current value and an output of the module for the closed-loop control of the mechanical field weakening to the first calculator for addition/subtraction.

3. The method of claim 1, wherein further comprising:
supplying a measured current of the electric machine to a phase angle table of the module for the closed-loop control of the mechanical field weakening.

4. The method of claim 1, wherein the module for the target open-loop control values comprises a memory for tables which includes target current values and target values for the mechanical field weakening, wherein these target values are optimized with regard to an efficiency of the electric machine, the efficiency of an overall drive system or the acoustics, wherein the torque target value, the actual speed value and the actual supply voltage value are supplied to the memory.

5. The method of claim 1, wherein the module comprises an additional sensor system for observing the mechanical field weakening, with which the state of the mechanical field weakening is determined.

6. The method of claim 5, further comprising: supplying at least one measured current, at least one target or measured voltage, model knowledge and further parameters to the module for observing the mechanical field weakening.

7. The method of claim 6, wherein the parameter is at least one rotor position.

8. The method of claim 1, wherein the module for the closed-loop current control comprises a PID controller to which the output of the first calculator is supplied and an output of the PID controller is supplied to a compensation of the interference voltage due to a change in the state of the mechanical field weakening for determining the target value of the inverter voltage.

9. The method of claim 1, wherein the module for the closed-loop control of the mechanical field weakening comprises a PID controller to which the output of the second calculator is supplied and an output of the PID controller is supplied to a phase angle table which determines an optimization with regard to the maximum effect of an adjustment of the mechanical field weakening and outputs a target value of the current which influences the mechanical field weakening and supplies it to the closed-loop current control via the first calculator.

10. A use of the method according to claim 1 for the closed-loop control and influencing of the state of the mechanical field weakening of an electric machine.
